(19) United States
(12) Patent Application Publication
(10) Pub. No.: US 2005/0157456 A1
(43) Pub. Date: Jul. 21, 2005

(54) Modularized electronic device coupling architecture and method

(76) Inventors: Yaz-Tzu Wu, Taipei (TW); Spring Liu, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/761,587

(22) Filed: Jan. 20, 2004

(51) Int. Cl. G06F 1/16

(52) U.S. Cl. 361/681

(57) ABSTRACT

A modularized electronic device coupling architecture and method is proposed, which is designed for the coupling of a first modularized electronic device with a second modularized electronic device, such as a tablet computer to a keyboard/touchpad base, so as to allow the tablet computer to use the data input capability provided by the keyboard/touchpad base and additionally allow the tablet computer have collapsible, rotatable, and dismountable capabilities, and also allows the user to dismount the tablet computer from the keyboard/touchpad base effortlessly by hand and use the tablet computer as an independent functional unit.

### BACKGROUND OF THE INVENTION

1. Field of the Invention

This invention relates to computer technology, and more particularly, to a modularized electronic device coupling architecture and method, which is designed for the coupling of a first modularized electronic device with a second modularized electronic device in such a manner as to allow the first modularized electronic device to have collapsible, rotatable, and dismountable capabilities over the second modularized electronic device.

2. Description of Related Art

Tablet computer is a slimmed type of portable personal computer that is characterized by that it is shaped like a tablet and has only a display screen without keyboard and pointing device (mouse or touchpad). To input data to a tablet computer, the user needs just to use fingertips to touch specific graphic icons on the screen to choose commands and use handwriting method to input text into the tablet computer. Since the tablet computer is very small in size, it provide a high level of portability for the user on the road.

Despite that a tablet computer has no keyboard and pointing device, an external keyboard/touchpad base can be optionally attached to the tablet computer to allow the user to conveniently input data and commands to the tablet computer via the externally-attached keyboard/touchpad base.

There are presently various sorts of keyboard/touchpad bases on the market for the user to choose to attach to the tablet computer. One drawback to the present keyboard/touchpad bases, however, is that it is incapable of allowing the tablet computer to have collapsible, rotatable, and dismountable capabilities; i.e., some tablet computers have collapsible and rotatable, but no dismountable capability; and some others have dismountable capability, but no collapsible and rotatable capabilities. Moreover, if the user wants to dismount the tablet computer from the keyboard/touchpad base, it is required to first turn off the power of the tablet computer and then use assisting tools to unlock the engagement between the tablet computer and the keyboard/touchpad base, which is quite inconvenient. Therefore, conventional tablet computers still need improvements on these drawbacks.

### SUMMARY OF THE INVENTION

It is therefore an objective of this invention to provide a modularized electronic device coupling architecture and method which can be used to attach a tablet computer to a keyboard/touchpad base and allows the attached tablet computer to have collapsible, rotatable, and dismountable capabilities.

It is another objective of this invention to provide a modularized electronic device coupling architecture and method which allows the user to dismount a tablet computer from the keyboard/touchpad base and use the tablet computer independently as a computer unit.

The modularized electronic device coupling architecture and method of the invention is designed for the coupling of a first modularized electronic device with a second modularized electronic device, such as a tablet computer to a keyboard/touchpad base, so as to allow the tablet computer to use the data input capability provided by the keyboard/touchpad base, and allows the user to dismount the tablet computer from the keyboard/touchpad base effortlessly without having to use assisting tools and use the detached tablet computer as an independent computer unit.

The modularized electronic device coupling method according to the invention comprises: providing a pivot mechanism and a rotation mechanism respectively on the first modularized electronic device and the second modularized electronic device; engaging the pivot mechanism with the rotation mechanism so as to mechanically and electrically couple the first modularized electronic device with the second modularized electronic device; and using the second modularized electronic device as a data input interface for the first modularized electronic device, wherein the first modularized electronic device is collapsible and rotatable on the second modularized electronic device, and is dismountable and hot-unpluggable from the second modularized electronic device to serve as an independent functional unit.

In addition, when the tablet computer is attached to the keyboard/touchpad base, the invention allows the tablet computer to have collapsible and rotatable capabilities that allow the utilization of tablet computer to be more flexible and convenient.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the modularized electronic device coupling architecture of the invention being used to connect a tablet computer to a keyboard/touchpad base;

FIG. 2 shows the same of FIG. 1 while the tablet computer is dismounted from the keyboard/touchpad base;

FIG. 3 shows a schematic exploded perspective view of the modularized electronic device coupling architecture of the invention;

FIG. 4 shows a schematic perspective view of the modularized electronic device coupling architecture of the invention when assembled;

FIG. 5 shows a schematic sectional view of the engaging mechanism utilized by the modularized electronic device coupling architecture of the invention; and

FIG. 6 is a flow diagram showing the procedural steps involved in the modularized electronic device coupling method of the invention.

### DETAILED DESCRIPTION OF PREFERRED EMBODIMENTS

The modularized electronic device coupling architecture and method according to the invention is disclosed in full details by way of several preferred embodiments in the following with reference to the accompanying drawings.

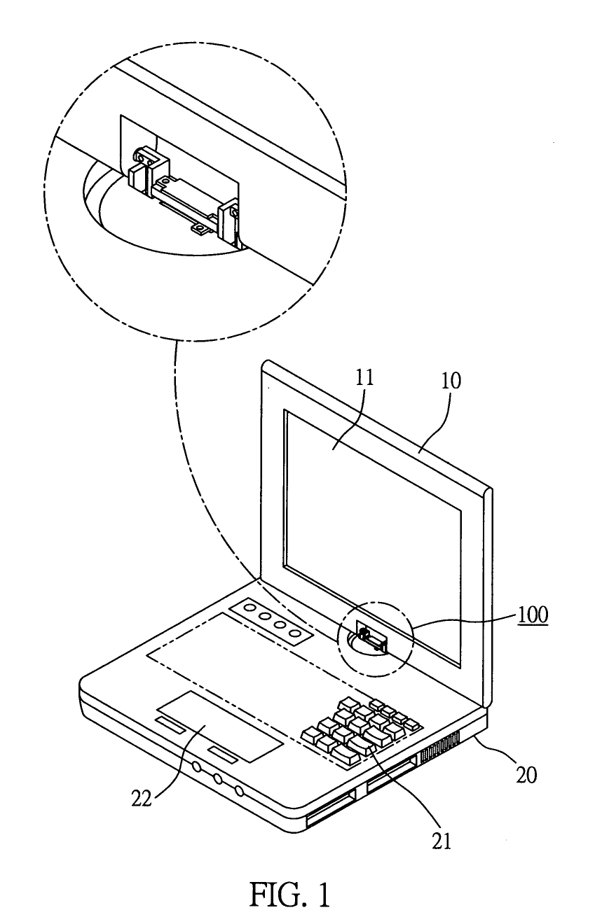

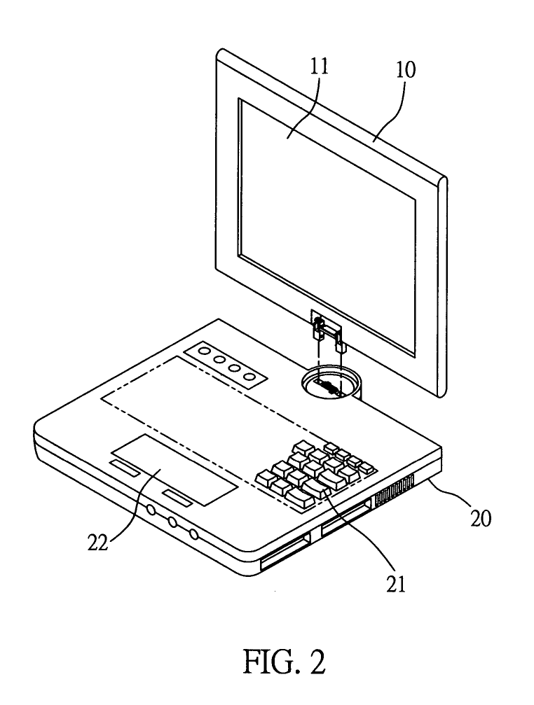

Referring to FIG. 1 and FIG. 2, the modularized electronic device coupling architecture of the invention (as the part enclosed in the dotted circle indicated by the reference numeral 100) is used to couple a first modularized electronic device 10, such as a tablet computer, an LCD (Liquid Crystal Display) screen, and so on, with a second modularized electronic device 20, such as a keyboard/touchpad base or a notebook's main system unit. In this embodiment, for example, the first modularized electronic device 10 is a tablet computer which is equipped with a display screen 11 and internal hardware/software modules (not shown) that allow the tablet computer to operate independently for data input and processing; and the second modularized electronic device 20 is for example a keyboard/touchpad base which is equipped with a keyboard 21 and a touchpad 22.

As illustrated in FIG. 1, as the tablet computer 10 is mounted in position on the keyboard/touchpad base 20, the modularized electronic device coupling architecture of the invention 100 allows the tablet computer 10 to have collapsible, rotatable, and dismountable capabilities; i.e., the invention allows the tablet computer 10 to be flatly collapsible against the keyboard/touchpad base 20, rotatable over the keyboard/touchpad base 20 to any desired direction, and dismountable from the keyboard/touchpad base 20 as illustrated in FIG. 2.

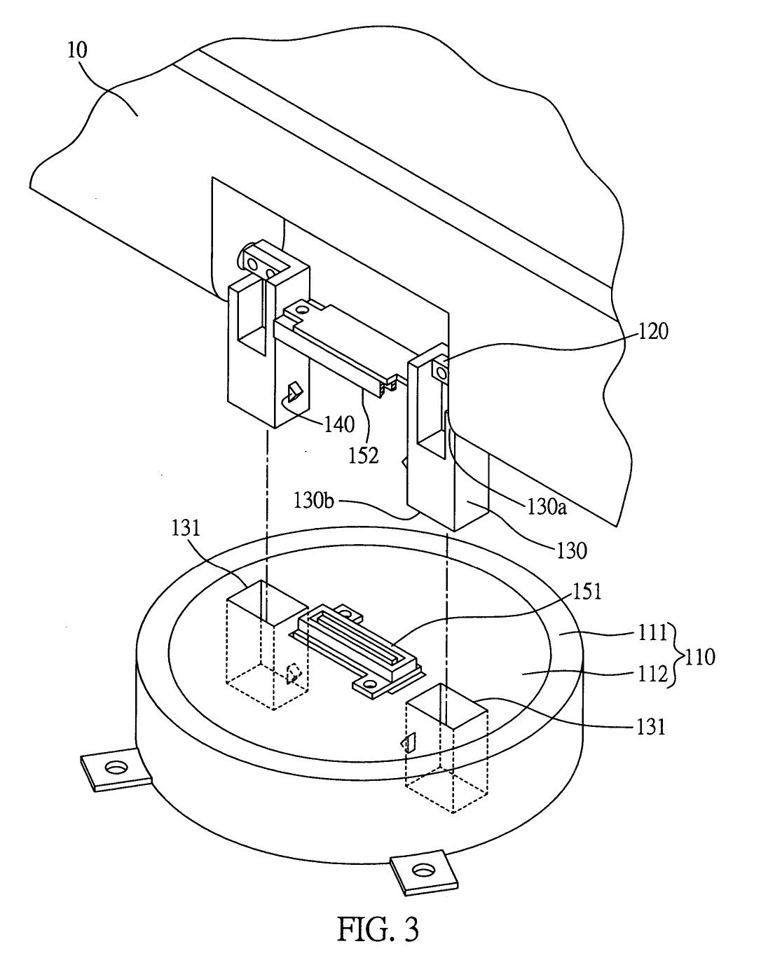

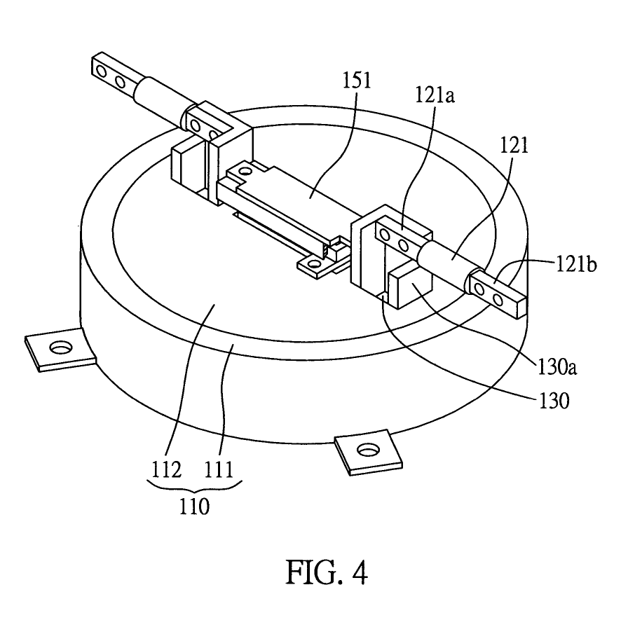

As shown in FIG. 3 and FIG. 4, the modularized electronic device coupling architecture of the invention 100 comprises a mechanical linking mechanism and an electrical linking mechanism, wherein the mechanical linking mechanism includes: comprises: (a) a rotation mechanism 110; (b) a pivot mechanism 120; (c) at least an insert leg 130 (in this embodiment, 2 insert legs 130 are provided); (d) an engaging mechanism 140; while the electrical linking mechanism includes a first-type connector 151 and a second-type connector 152 compatible with the first-type connector 151.

The rotation mechanism 110 is arranged on the keyboard/touchpad base 20, and which includes a fixed portion 111 and a circular rotatable portion 112, wherein the fixed portion 111 is fixed to the keyboard/touchpad base 20 while the circular rotatable portion 112 is rotatable on the fixed portion 111. In addition, the circular rotatable portion 112 is formed with at least one engaging hole (in this embodiment, two engaging holes 131 are provided) corresponding in size and position to the insert legs 130.

The pivot mechanism 120 is fixed to one side of the tablet computer 10, and which includes at least one rotating shaft (in this embodiment, two rotating shafts 121 are provided) that allows the body of the tablet computer 10 to be rotatable thereabout. Each of the rotating shafts 121 includes a first end 121a and a second end 121b, wherein the first end 121a is exposed to the outside of the casing of the tablet computer 10, while the second end 121b is rotatably linked to the inside of the casing of the tablet computer 10.

Each of the insert legs 130 has a first end 130a and a second end 130b, wherein the first end 130a is fixedly linked to the first end 121a of one of the rotating shafts 121 on the pivot mechanism 120, while the second end 130b is used for insertion into one of the engaging holes 131 in the circular rotatable portion 112 on the rotation mechanism 110.

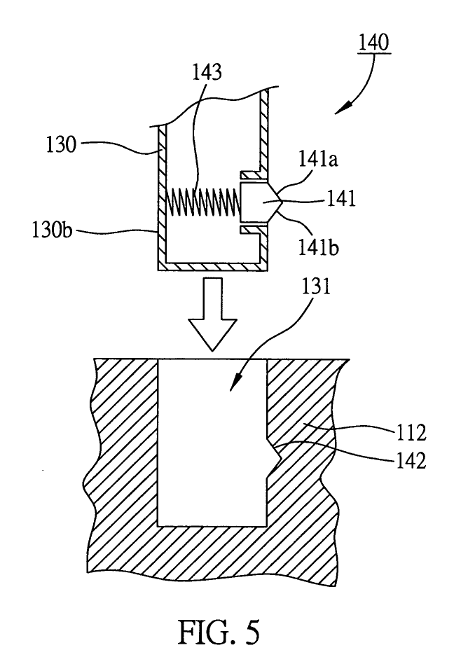

As shown in FIG. 5, when the respective second ends 130b the insert legs 130 are inserted in the engaging holes 131 in the circular rotatable portion 112 of the rotation mechanism 110, the engaging mechanism 140 will lock the insert legs 130 in position. The engaging mechanism 140 includes an elastic locking member 141 and a corresponding locking hole 142, wherein the elastic locking member 141 is arranged on the second end 130b of each of the insert legs 130, while the locking hole 142 is arranged on the bottom inner wall of each engaging hole 131 in the circular rotatable portion 112 (in various other embodiment, elastic locking member 141 and the locking hole 142 can be exchanged in their locations, i.e., the elastic locking member 141 is arranged on the bottom inner wall of each engaging hole 131 in the circular rotatable portion 112, while the locking hole 142 is arranged on the second end 130b of each of the insert legs 130). The elastic locking member 141 has an upward-facing sliding surface 141a and a downward-facing sliding surface 141b. When a pressing force is acting on either the upward-facing sliding surface 141a or the downward-facing sliding surface 141b, it will urge the elastic locking member 141 into the inside of the insert legs 130; and when the pressing force is removed, the elastic locking member 141 will restore to its original position on the outside of the insert legs 130 by means of an elastic restoration force from an elastic member, such as a spring 143. The locking hole 142 is used to receive the elastic locking member 141 and lock the insert legs 130 securely in position in the engaging holes 131 when the second end 130b of the insert legs 130 is inserted in position in the engaging holes 131.

In this embodiment, for example, the first-type connector 151 and the second-type connector 152 are respectively a male-type USB (Universal Serial Bus) connector and a female-type USB connector. The first-type connector 151 is arranged on the circular rotatable portion 112 of the rotation mechanism 110 on the keyboard/touchpad base 20, while the second-type connector 152 is arranged beside the pivot mechanism 120 on the tablet computer 10. When the first-type connector 151 is coupled to the second-type connector 152, it establish an electrical link between the tablet computer 10 and the keyboard/touchpad base 20 that allows the tablet computer 10 and the keyboard/touchpad base 20 to exchange data, i.e., the user can operate and key in data to the tablet computer 10 via the keyboard/touchpad base 20.

When the user wants to attach the tablet computer 10 to the keyboard/touchpad base 20, he/she simply needs to align and press down the second end 130b of the insert legs 130 on the tablet computer 10 against the engaging holes 131 in the circular rotatable portion 112 of the rotation mechanism 110. This allows the upward-facing sliding surface 141a of the elastic locking member 141 to be urged by the inner wall of the engaging holes 131 and thereby being pushed into the inside of the insert legs 130, allowing the insert legs 130 to penetrate into the engaging holes 131. When the second end 130b of the insert legs 130 is inserted in position, the elastic locking member 141 will be restored to its original position by means of the elastic restoration force from the spring 143 and thereby flipped into the locking hole 142 to be locked by the locking hole 142. This allows the tablet computer 10 to be securely mounted on the keyboard/touchpad base 20. Meanwhile, the first-type connector 151 is also urged to be coupled to the second-type connector 152, allowing the tablet computer 10 to communicate with the keyboard/touchpad base 20 for data exchange. In this embodiment, for example, the first-type connector 151 is hot-pluggable to the second-type connector 152, which allows the tablet computer 10 to promptly establish a data communication link with the keyboard/touchpad base 20 immediately after the first-type connector 151 is coupled with the second-type connector 152. Since hot plug is a well-known and widely used technology, detailed description thereof will not be given in this specification.

When the tablet computer 10 is mounted in position on the keyboard/touchpad base 20, the circular rotatable portion 112 of the rotation mechanism 110 allows the tablet computer 10 to be rotatable on the keyboard/touchpad base 20 so as to turn the display screen 11 of the tablet computer 10 to any desired direction for convenient viewing. Moreover, the pivot mechanism 120 allows the tablet computer 10 to be flatly collapsible against the top surface of the keyboard/touchpad base 20 for convenient carrying on the road by the user.

When the user wants to dismount the tablet computer 10 from the keyboard/touchpad base 20, he/she needs just to forcefully pull the tablet computer 10 away from the keyboard/touchpad base 20. This causes the downward-facing sliding surface 141b of the elastic locking member 141 to be urged by the inner wall of the engaging holes 131 and thereby being pushed into the inside of the insert legs 130, allowing the insert legs 130 to be freely withdrawable from the engaging holes 131, thereby disengaging the tablet computer 10 from the keyboard/touchpad base 20.

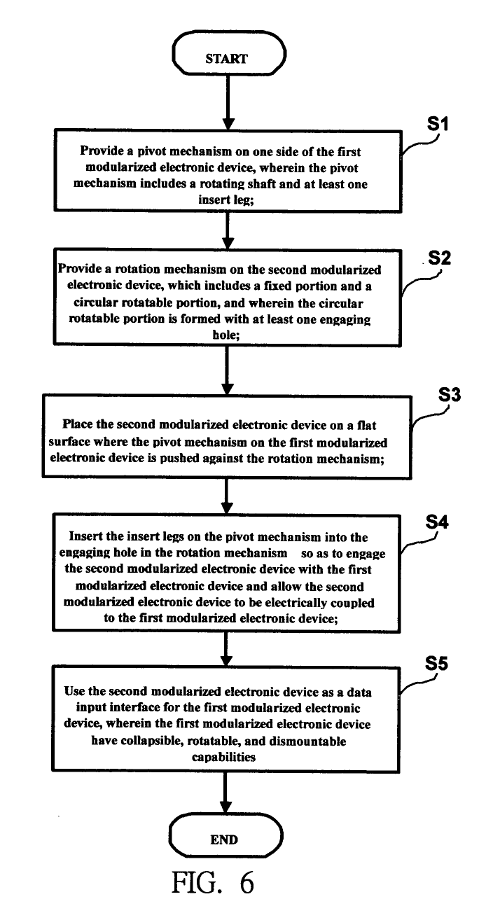

FIG. 6 is a flow diagram showing the procedural steps involved in the modularized electronic device coupling method of the invention. As shown, in the first step S1, a pivot mechanism 120 is provided on one side of the first modularized electronic device, such as a tablet computer 10, wherein the pivot mechanism 120 includes a rotating shaft 121 and at least one insert leg 130, and the rotating shafts 121 allows the tablet computer 10 to rotate about the rotating shafts 121. Then, the procedural step goes to the step S2.

In the step S2, a rotation mechanism 110 is provided on the second modularized electronic device, such as a keyboard/touchpad base 20, which includes a fixed portion 111 and a circular rotatable portion 112, wherein the fixed portion 111 is fixed to the keyboard/touchpad base 20 while the circular rotatable portion 112 is rotatable on the fixed portion 111. In addition, the circular rotatable portion 112 is formed with at least one engaging hole (in this embodiment, two engaging holes 131 are provided) corresponding in size and position to the insert legs 130. Then, the procedural step goes tot he step S3.

In the step S3, the keyboard/touchpad base 20 is placed on a flat surface where the pivot mechanism 120 on the tablet computer 10 is forcefully pushed by hand against the rotation mechanism 110 on the keyboard/touchpad base 20. The procedural step then goes tot he S4.

In the step S4, the insert legs 130 on the pivot mechanism 120 are inserted into the engaging hole 131 in the rotation mechanism 110 so as to engage the tablet computer 10 with the keyboard/touchpad base 20 and allow the tablet computer 10 to be electrically coupled to the keyboard/touchpad base 20. The procedural step then goes to the step S5.

In the step S5, the keyboard/touchpad base 20 is used as a data input interface for the tablet computer 10, wherein the tablet computer 10 have collapsible, rotatable, and dismountable capabilities that allows the user to flatly collapse the tablet computer 10 against the top surface of the keyboard/touchpad base 20, rotate the tablet computer 10 on the keyboard/touchpad base 20, and dismount the tablet computer 10 from the keyboard/touchpad base 20 even when the tablet computer 10 is presently powered on so as to use the detached tablet computer 10 as an independent computer unit.

In conclusion, the invention provides a modularized electronic device coupling architecture and method, which is designed for the coupling of a first modularized electronic device with a second modularized electronic device, such as a tablet computer to a keyboard/touchpad base, so as to allow the tablet computer to use the data input capability provided by the keyboard/touchpad base, and allows the user to dismount the tablet computer from the keyboard/touchpad base effortlessly without having to use assisting tools and use the detached tablet computer as an independent computer unit. Furthermore, the modularized electronic device coupling architecture and method according to the invention allows the attached tablet computer to have collapsible and rotatable capabilities, so that the utilization of the tablet computer is more flexible and convenient. The invention is therefore more advantageous to use and highly inventive than the prior art

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A modularized electronic device coupling architecture for the coupling of a first modularized electronic device with a second modularized electronic device wherein the first modularized electronic device is independently operable when dismounted from the second modularized electronic device;
the modularized electronic device coupling architecture comprising:
a rotation mechanism, which includes a fixed portion and a circular rotatable portion, wherein the fixed portion is fixed to the second modularized electronic device while the circular rotatable portion is rotatable on the fixed portion, and wherein the circular rotatable portion is formed with at least one engaging hole;
a pivot mechanism, which is fixed to one side of the tablet computer, and which includes at least one rotating shaft that allows the first modularized electronic device to be rotatable thereabout; and
at least one insert leg, which has a first end and a second end, wherein the first end is fixedly linked to the first end of the rotating shaft on the pivot mechanism, while the second end is used for insertion into the engaging hole in the circular rotatable portion on the rotation mechanism.

2. The modularized electronic device coupling architecture of claim 1, wherein the first modularized electronic device is a tablet computer, while the second modularized electronic device is a keyboard/touchpad base.

3. The modularized electronic device coupling architecture of claim 1, wherein the first modularized electronic device is a tablet computer, while the second modularized electronic device is a notebook base unit.

4. The modularized electronic device coupling architecture of claim 1, wherein the first modularized electronic device is a liquid crystal display unit, while the second modularized electronic device is a notebook base unit.

5. The modularized electronic device coupling architecture of claim 1, further comprising:
a first-type connector, which is arranged on the circular rotatable portion of the rotation mechanism; and
a second-type connector, which is arranged beside the pivot mechanism, and which is coupled to the first-type connector when the insert leg is inserted in position in the engaging hole in the circular rotatable portion of the rotation mechanism to thereby establish a data communication link between the first modularized electronic device and the second modularized electronic device.

6. The modularized electronic device coupling architecture of claim 5, wherein the first-type connector is hot pluggable to the second-type connector.

7. The modularized electronic device coupling architecture of claim 5, wherein the first-type connector and the second-type connector are USB (Universal Serial Bus) compliant connectors.

8. The modularized electronic device coupling architecture of claim 1, further comprising:
an engaging mechanism, which is capable of engaging the insert legs in position in the engaging holes in the circular rotatable portion of the rotation mechanism.

9. The modularized electronic device coupling architecture of claim 8, wherein the engaging mechanism includes:
an elastic locking member, which is arranged on the second end of each of the insert legs, and which is capable of being positioned on the inside of the insert leg when subjected to an external force and positioned on the outside of the insert leg when the external force is removed; and
a locking hole structure, which is formed in the inner wall of the engaging hole in the circular rotatable portion of the rotation mechanism, and which is capable of locking the insert leg securely in position when the second end of the insert leg is inserted in position in the engaging hole.

10. A modularized electronic device coupling architecture for the coupling of a first modularized electronic device with a second modularized electronic device wherein the first modularized electronic device is independently operable when dismounted from the second modularized electronic device;
the modularized electronic device coupling architecture comprising:
a rotation mechanism, which includes a fixed portion and a circular rotatable portion, wherein the fixed portion is fixed to the second modularized electronic device while the circular rotatable portion is rotatable on the fixed portion, and wherein the circular rotatable portion is formed with at least one engaging hole;
a pivot mechanism, which is fixed to one side of the tablet computer, and which includes at least one rotating shaft that allows the first modularized electronic device to be rotatable thereabout;
at least one insert leg, which has a first end and a second end, wherein the first end is fixedly linked to the first end of the rotating shaft on the pivot mechanism, while the second end is used for insertion into the engaging hole in the circular rotatable portion on the rotation mechanism;
a first-type connector, which is arranged on the circular rotatable portion of the rotation mechanism; and
a second-type connector, which is arranged beside the pivot mechanism, and which is coupled to the first-type connector when the insert leg is inserted in position in the engaging hole in the circular rotatable portion of the rotation mechanism to thereby establish a data communication link between the first modularized electronic device and the second modularized electronic device.

11. The modularized electronic device coupling architecture of claim 10, wherein the first modularized electronic device is a tablet computer, while the second modularized electronic device is a keyboard/touchpad base.

12. The modularized electronic device coupling architecture of claim 10, wherein the first modularized electronic device is a tablet computer, while the second modularized electronic device is a notebook base unit.

13. The modularized electronic device coupling architecture of claim 10, wherein the first modularized electronic device is a liquid crystal display unit, while the second modularized electronic device is a notebook base unit.

14. The modularized electronic device coupling architecture of claim 10, wherein the first-type connector and the second-type connector are USB (Universal Serial Bus) compliant connectors.

15. The modularized electronic device coupling architecture of claim 10, further comprising:
an engaging mechanism, which is capable of engaging the insert legs in position in the engaging holes in the circular rotatable portion of the rotation mechanism.

16. The modularized electronic device coupling architecture of claim 10, wherein the engaging mechanism includes:
an elastic locking member, which is arranged on the second end of each of the insert legs, and which is capable of being positioned on the inside of the insert leg when subjected to an external force and positioned on the outside of the insert leg when the external force is removed; and
a locking hole structure, which is formed in the inner wall of the engaging hole in the circular rotatable portion of the rotation mechanism, and which is capable of locking the insert leg securely in position when the second end of the insert leg is inserted in position in the engaging hole.

17. A modularized electronic device coupling method for the coupling of a first modularized electronic device with a second modularized electronic device;
the modularized electronic device coupling method comprising:
providing a pivot mechanism and a rotation mechanism respectively on the first modularized electronic device and the second modularized electronic device;
engaging the pivot mechanism with the rotation mechanism so as to mechanically and electrically couple the first modularized electronic device with the second modularized electronic device; and
using the second modularized electronic device as a data input interface for the first modularized electronic device, wherein the first modularized electronic device is collapsible and rotatable on the second modularized electronic device, and is dismountable and hot-unpluggable from the second modularized electronic device to serve as an independent functional unit.

18. The modularized electronic device coupling method of claim 17, wherein the first modularized electronic device includes a CPU and associated hardware/software facilities that allow the first modularized electronic device to operate independently as a data input and processing unit.

19. The modularized electronic device coupling method of claim 18, wherein the hardware/software facilities are selected from the group comprising memory, hard disks, and operating systems.

20. The modularized electronic device coupling method of claim 17, wherein the first modularized electronic device is a tablet computer, while the second modularized electronic device is a keyboard/touchpad base.

21. The modularized electronic device coupling architecture of claim 17, wherein the first modularized electronic device is a tablet computer, while the second modularized electronic device is a notebook base unit.

22. The modularized electronic device coupling architecture of claim 17, wherein the first modularized electronic device is a liquid crystal display unit, while the second modularized electronic device is a notebook base unit.

23. The modularized electronic device coupling method of claim 17, wherein a first-type connector and a second-type connector respectively provided on the first modularized electronic device and the second modularized electronic device are used to electrically couple the first modularized electronic device to the second modularized electronic device.

24. The modularized electronic device coupling method of claim 17, wherein a first-type connector and the second-type connectors are USB (Universal Serial Bus) connectors.

25. The modularized electronic device coupling method of claim 17, wherein when the first modularized electronic device is detached from the second modularized electronic device, the first modularized electronic device is operable as an independent data input and processing unit.
